(19) United States
(12) Patent Application Publication
(10) Pub. No.: US 2019/0196138 A1
(43) Pub. Date: Jun. 27, 2019

(54) CAMERA MODULE

(71) Applicant: CM Technology Co., Ltd., Tokyo (JP)

(72) Inventor: Yutaka USHIODA, Tokyo (JP)

(73) Assignee: CM Technology Co., Ltd., Tokyo (JP)

(21) Appl. No.: 16/023,769

(22) Filed: Jun. 29, 2018

(30) Foreign Application Priority Data
Dec. 22, 2017 (JP) 2017-245777

(51) Int. Cl. G02B 7/10; G02B 7/28; G02B 7/09; H04N 5/232

(52) U.S. Cl. CPC G02B 7/102; H04N 5/23229; G02B 7/09; G02B 7/282

(57) ABSTRACT

A camera module of the present invention includes two lens drive units adjacent to each other. The lens drive units each include a first drive mechanism that moves a lens along an optical axis direction and a second drive mechanism that moves the lens in a vertical direction to the optical axis direction. The second drive mechanism includes two voice coil motors that respectively move the lens in two linear directions orthogonal to each other. The lens drive unit has a substantially rectangular outline. The two voice coil motors of the second drive mechanism are respectively installed near two neighboring sides of four sides forming an outer perimeter of the substantially rectangular lens drive unit. The two lens drive units are installed so that none of the voice coil motors are located on at least one of sides where the lens drive units are located adjacent to each other.

### TECHNICAL FIELD

The present invention relates to a camera module.

### BACKGROUND ART

A recent information processing terminal such as a smartphone and a tablet terminal is equipped with a compact camera module for taking an image. Such a camera module includes a lens drive unit that has an autofocus function to automatically focus at the time of taking an image of an object and a stabilizer function to optically compensate for camera shake occurring at the time of taking an image to reduce blur of the image.

The autofocus function of the lens drive unit is realized by a voice coil motor that includes a magnet and a coil as shown in Patent Document 1, for example. Use of drive force of the voice coil motor reciprocates a lens to along an optical axis direction. With this, the lens drive unit supports reciprocation of the lens along the optical axis direction by the autofocus function with the use of a guide ball placed around.

Further, the stabilizer function of the lens drive unit includes, for example, a magnet mounted on a housing that houses a lens barrel and a coil installed on a bottom cover. Applying electric current to the coil in such a configuration causes drive force to move the housing that houses the lens barrel in predetermined one direction on a vertical plane to the optical axis direction of the lens. With two voice coil motors each including the magnet and the coil, it is possible to drive the housing to reciprocate in two linear directions (X-axis direction and Y-axis direction) orthogonal to each other on the vertical plane to the optical axis direction of the lens.

In recent years, an information processing terminal equipped with two cameras that image in the same directions, namely, a dual camera has appeared. Imaging in the same directions with two cameras allows acquisition of various captured image information and enhancement of an imaging function.

Patent Document 1: Japanese Unexamined Patent Application Publication No. JP-A 2015-180937

As described above, for mounting a dual camera on an information processing terminal, there is a need to set camera modules close to each other. Then, there is a case where magnets included by stabilizer functions of the camera modules are close to each other, and magnetic interference may thereby occur. Such magnetic interference may cause a problem of trouble and decline of accuracy in the stabilizer function.

### SUMMARY OF THE INVENTION

Accordingly, an object of the present invention is to solve the abovementioned problem, namely, a problem of decline of a stabilizer function of a lens drive unit in a dual camera.

A camera module as an aspect of the present invention is a camera module equipped with two lens drive units adjacent to each other.

The lens drive units each include a first drive mechanism configured to move a lens along an optical axis direction and a second drive mechanism configured to move the lens in a vertical direction to the optical axis direction.

The second drive mechanism includes two voice coil motors that respectively move the lens in two linear directions orthogonal to each other on a vertical plane to the optical axis direction of the lens.

Each of the lens drive units has a substantially rectangular outline.

The two voice coil motors configuring the second drive mechanism are respectively installed near two sides neighboring each other of four sides forming an outer perimeter of the substantially rectangular lens drive unit.

The two lens drive units are installed so that none of the voice coil motors are located on at least one of sides where the lens drive units are located adjacent to each other.

Moreover, in the camera module,

the two lens drive units are installed so that none of the voice coil motors are located on the sides where the lens drive units are located adjacent to each other.

Moreover, in the camera module,

the two lens drive units are installed so that the voice coil motors are located symmetrical about a symmetric line, the symmetric line being the sides where the lens drive units are located adjacent to each other.

Moreover, in the camera module,

the two lens drive units are installed so that the voice coil motors are located symmetrical about a symmetric point, the symmetric point being near a center of the sides where the lens drive units are located adjacent to each other.

Further, the present invention also provides an information processing terminal equipped with the camera module described above.

According to the camera module of the present invention, the voice coil motors for realizing the stabilizer functions of the lens drive units configuring the dual camera are not installed adjacent to each other, magnetic interference can be thereby inhibited. As a result, it is possible to inhibit decline of the stabilizer function of the lens drive unit.

### BRIEF DESCRIPTION OF DRAWINGS

FIG. 1 is a view showing a configuration of a camera module in a first exemplary embodiment of the present invention;

FIG. 2 is a view showing a configuration and operation of a lens drive unit configuring the camera module disclosed in FIG. 1;

FIG. 3 is a view showing an example of arrangement of the lens drive units in the camera module disclosed in FIG. 1;

FIG. 4 is a view showing an example of arrangement of the lens drive units in the camera module disclosed in FIG. 1;

FIG. 5 is a view showing an example of arrangement of the lens drive units in the camera module disclosed in FIG. 1;

FIG. 6 is a view showing a configuration of a camera module according to a second exemplary embodiment of the present invention; and

FIG. 7 is a view showing a configuration and operation of a lens drive unit configuring the camera module disclosed in FIG. 6.

### EXEMPLARY EMBODIMENT

### <First Exemplary Embodiment>

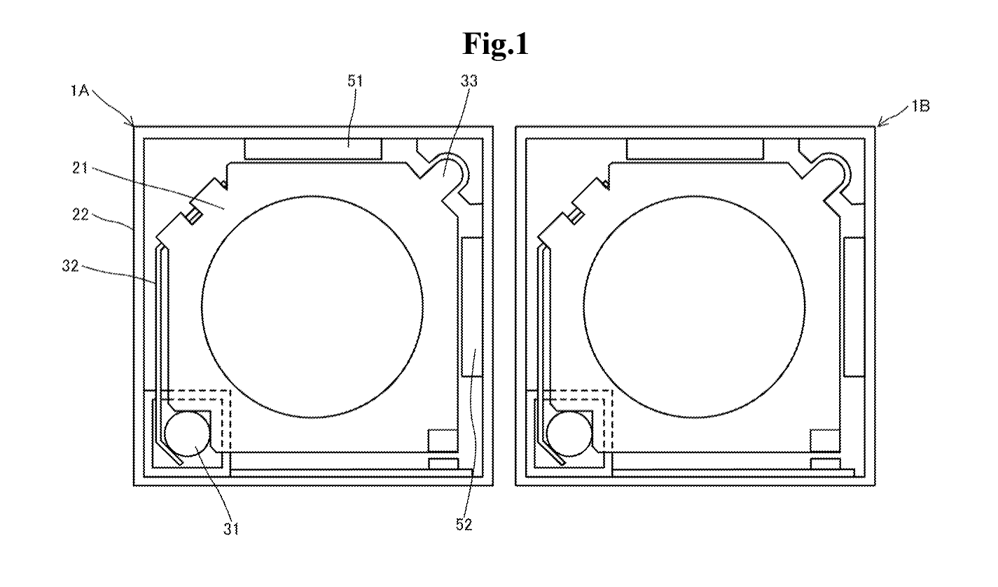

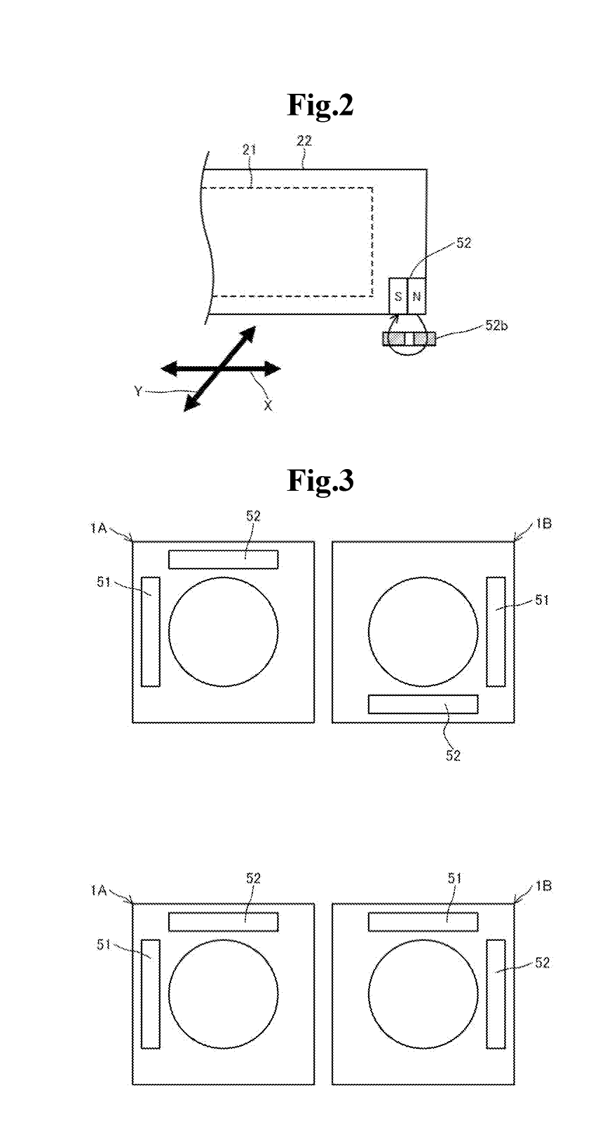

A first exemplary embodiment of the present invention will be described with reference to FIGS. 1 to 5. FIGS. 1 and 2 are views showing a configuration of a camera module. FIGS. 3 to 5 are views showing arrangement of lens drive units configuring the camera module.

The camera module according to the present invention is, for example, for taking an image, mounted on an information processing terminal such as a smartphone and a tablet terminal. However, the camera module according to the present invention is not necessarily limited to being mounted on an information processing terminal, and may be mounted on other electronic equipment or various types of equipment.

With reference to FIG. 1, the configuration of the camera module will be described. FIG. 1 is a plan view showing the configuration of the camera module in a simplified manner. In the drawings of this application, part of the configuration is omitted for clarity of a structure.

The camera module according to the present invention is a dual camera including two cameras. Therefore, the camera module includes two lens drive units 1A and 1B. As shown in FIG. 1, the lens drive units 1A and 1B are installed adjacent to each other. To be specific, the lens drive units 1A and 1B are formed so as to have substantially square outlines and are installed so that one sides of four sides forming outer perimeters are parallel to each other and adjacent to the other. The outlines of the lens drive units 1A and 1B are not limited to be square and may be rectangular, so that the outlines are formed so as to be substantially rectangular.

In this exemplary embodiment, the lens drive units 1A and 1B are the same ones. The lens drive units 1A and 1B each have an autofocus function to automatically focus at the time of taking an image of an object and a stabilizer function to optically compensate for camera shake occurring at the time of taking an image to reduce blur of the image. Below, configurations of the lens drive unit that realize the autofocus function and the stabilizer function will be mainly described, but the lens drive units may each have a function other than the functions illustrated in this exemplary embodiment. The lens drive units 1A and 1B may have different configurations from each other as far as magnets serving as the configuration for realizing the stabilizer function are arranged in a manner described below.

The lens drive unit 1A configuring the camera module includes a cover (not shown in the drawings) that covers the top and a bottom cover (not shown in the drawings) that convers the bottom. In FIG. 1, the lens drive unit 1A is illustrated with the cover and the bottom cover omitted. The lens drive unit 1A includes a lens barrel 21 equipped with a lens (not shown in the drawings) and a housing 22 that surrounds the lens barrel 21 to house the lens barrel 21, in a space made by the cover and the bottom cover. In addition, the lens drive unit 1A includes a first drive mechanism (31, 32, 33) that moves the lens barrel along the optical axis direction of the lens with respect to the housing 22, and a second drive mechanism (51, 52) that moves the housing 22 in a vertical direction to the optical axis direction of the lens with respect to the bottom cover. Below, each configuration will be described in detail.

The lens barrel 21 has an outline formed into a substantially rectangular shape. At the center of the lens barrel 21, a lens housing hole for housing the lens is formed. Moreover, the housing 22 is formed by, for example, four side walls and is a tubular member that has a substantially rectangular end face, and houses the lens barrel 21 inside.

The first drive mechanism (31, 32, 33) is a configuration that moves the lens barrel 21 along the optical axis direction of the lens, namely, along a vertical direction to the page of FIG. 1 and thereby realizes the autofocus function. To be specific, the first drive mechanism (31, 32, 33) in this exemplary embodiment drives the lens barrel 21 by SIDM (Smooth Impact Drive Mechanism) method, and has a drive shaft 31 serving as a piezoelectric actuator, a spring mechanism 32 and a guide mechanism 33.

The drive shaft 31 is a cylindrical shaft member that is installed on the housing 22 and extends along the thickness direction of the lens barrel 21, namely, along the optical axis direction of the lens. The drive shaft 31 is installed so that its lateral face contacts a concave part formed at a corner position between two neighboring sides of the rectangular lens barrel 21. The drive shaft 31 is configured to be stretched and contracted in its length direction by a piezoelectric element that is not shown in the drawings.

Further, the spring mechanism 32 is installed on the housing 22 or the bottom cover (not shown in the drawings) and presses the drive shaft 31 against the concave part formed at the corner of the lens barrel 21. Consequently, the drive shaft 31 and the lens barrel 21 are engaged by friction force and can thereby move the lens barrel 21 in the optical axis direction as the drive shaft 31 stretches and contracts.

Further, the guide mechanism 33 is set at a corner position of the lens barrel 21 opposite the corner position where the drive shaft 31 contacts, across the lens barrel 21. The guide mechanism 33 includes a protruding part that protrudes from the lens barrel 21 and a housing concave part formed on the housing 22 to house the protruding part. The housing concave part is formed like a groove along the optical axis direction. Therefore, when the lens barrel 21 is moved along the optical axis direction of the lens barrel 21 by the drive shaft 31 as described above, the protruding part of the lens barrel 21 is guided by the housing concave part.

The second drive mechanism (51, 52) is a configuration that moves the lens barrel 21 in a vertical direction to the optical axis direction of the lens and thereby realizes the stabilizer function. To be specific, the second drive mechanism (51, 52) includes two voice coil motors 51 and 52 and moves the housing 22 that houses the lens barrel 21 with respect to the bottom cover. As shown in FIG. 1, the two voice coil motors 51 and 52 are respectively installed near two neighboring sides of four sides forming the outer perimeter of the substantially rectangular lens drive unit 1A. That is, the two voice coil motors 51 and 52 are respectively installed along and near the two sides orthogonal to each other.

One voice coil motor 51 is set near a side located on the upper side in FIG. 1 and moves the housing 22 in the vertical direction in FIG. 1. Moreover, the other voice coil motor 52 is set near a side located on the right side in FIG. 1 and moves the housing 22 in the horizontal direction in FIG. 1. Thus, the two voice coil motors 51 and 52 respectively move the lens in two linear directions orthogonal to each other on a vertical plane to the optical axis direction.

To be specific, one of the voice coil motors includes a magnet 51 installed on the lower face of the housing 22 and a coil (not shown in the drawings) set on the bottom cover so as to correspond to the magnet 51. Likewise, as shown in FIG. 2, the other voice coil motor includes a magnet 52 installed on the lower face of the housing 22 and a coil 52b set on the bottom cover so as to correspond to the magnet 52. The one voice coil motor including the magnet denoted by reference numeral 51 shown in FIG. 1, when electric current is applied to the coil corresponding to the magnet 51, moves the lens along one linear direction (Y-axis direction) on the vertical plane to the optical axis direction of the lens. Moreover, the other voice coil motor including the magnet denoted by reference numeral 52, when electric current is applied to the coil 52b corresponding to the magnet 52, moves the lens along the other linear direction (X-axis direction) orthogonal to the one linear direction on the vertical plane to the optical axis direction of the lens. To be specific, when electric current is applied to the coil 52b, due to the direction of the electric current and Fleming's left-hand rule, the lens barrel is driven to reciprocate along a direction (Z-axis direction) vertical to the optical axis direction of the lens.

As shown in FIG. 1, the other lens drive unit 1B included by the camera module has the same configuration as the lens drive unit 1A described above.

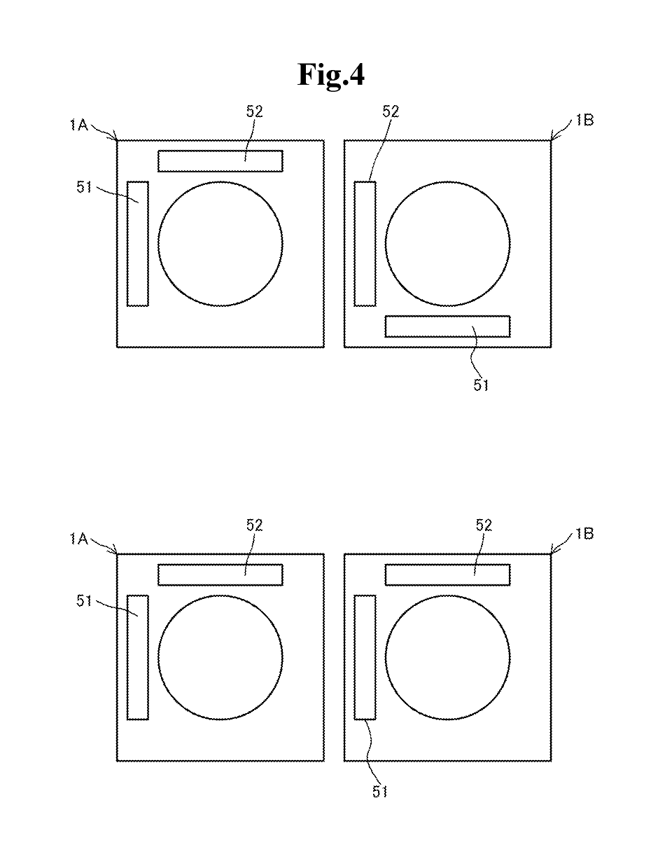

Furthermore, in this exemplary embodiment, the abovementioned two lens drive units 1A and 1B configuring the dual camera are installed as shown in FIG. 3 or 4. First, as shown in the upper view and the lower view of FIG. 3, the lens drive units 1A and 1B are installed so that the magnets 51 and 52 included by the voice coil motors are located on neither of sides where the lens drive units 1A and 1B are located adjacent to each other.

To be specific, in the example shown in the upper view of FIG. 3, one lens drive unit 1A located on the left is installed so that the magnets 51 and 52 are located near the left and upper sides of the outer perimeter, and the other lens drive unit 1B located on the right is installed so that the magnets 51 and 52 are located near the right and lower sides. Thus, the magnets 51 and 52 configuring the stabilizer function of the lens drive unit 1A and those of the lens drive unit 1B are installed so as to be located symmetrical about the vicinity of the center of the sides where the lens drive units 1A and 1B are located adjacent to each other. Consequently, neither of the magnets 51 and 52 are located at positions where the lens drive units 1A and 1B are adjacent to each other, so that magnetic interference can be inhibited.

Further, in the example shown in the lower view of FIG. 3, one lens drive unit 1A located on the left is installed so that the magnets 51 and 52 are located near the left and upper sides of the outer perimeter, and the other lens drive unit 1B located on the right is installed so that the magnets 51 and 52 are located near the upper and right sides. Thus, the magnets 51 and 52 configuring the stabilizer function of the lens drive unit 1A and those of the lens drive unit 1B are installed so as to be located symmetric about the sides where the lens drive units 1A and 1B are located adjacent to each other. Consequently, neither of the magnets 51 and 52 are not located at positions where the lens drive units 1A and 1B are adjacent to each other, so that magnetic interference can be inhibited.

Further, in this exemplary embodiment, as shown in the upper view and the lower view of FIG. 4, the two lens drive units 1A and 1B configuring the dual camera may be installed so that neither of the magnets 51 and 52 included by the voice coil motors are located on one of sides where the lens drive units 1A and 1B are located adjacent to each other.

To be specific, in the example shown in the upper view of FIG. 4, one lens drive unit 1A located on the left is installed so that the magnets 51 and 52 are located near the left and upper sides of the outer perimeter, and the other lens drive unit 1B located on the right is installed so that the magnets 51 and 52 are located near the lower and left sides. Thus, even if the magnet 52 of the lens drive unit 1B is located between the lens drive units 1A and 1B, magnetic interference can be inhibited.

Further, in the example shown in the lower view of FIG. 4, one lens drive unit 1A located on the left is installed so that the magnets 51 and 52 are located near the left and upper sides of the outer perimeter, and the other lens drive unit 1B located on the right is installed so that the magnets 51 and 52 are located near the left and upper sides. Thus, even if the magnet 52 of the lens drive unit 1B is located between the lens drive units 1A and 1B, magnetic interference can be inhibited.

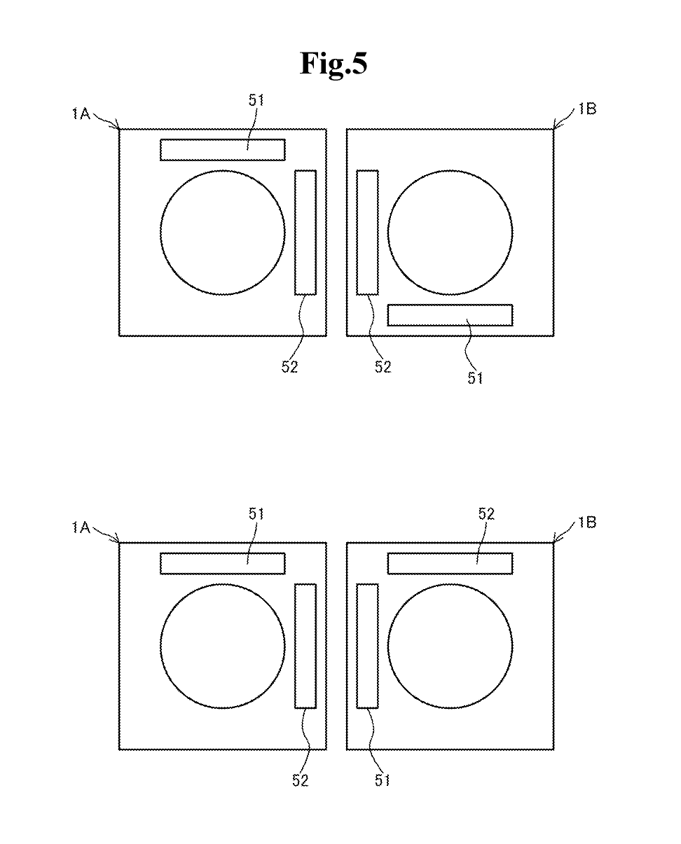

Examples shown in the upper and lower views of FIG. 5 are examples for comparison with the configurations of the present invention shown in FIGS. 3 and 4 described above. In a case where, as shown in the upper view and the lower view of FIG. 5, the magnets 51 and 52 configuring the stabilizer functions of the respective lens drive units 1A and 1B are located on sides where the lens drive units 1A and 1B are located adjacent to each other, magnetic interference may occur due to these magnets 51 and 52. Therefore, it is desirable to install as shown in FIG. 3 or 4.

As described above, according to the camera module of the present invention shown in FIGS. 3 and 4, the voice coil motors for realizing the stabilizer functions of the respective lens drive units configuring the dual camera are not installed adjacent to each other, so that it is possible to inhibit magnetic interference. As a result, it is possible to inhibit decline of the stabilizer function of the lens drive unit.

### <Second Exemplary Embodiment>

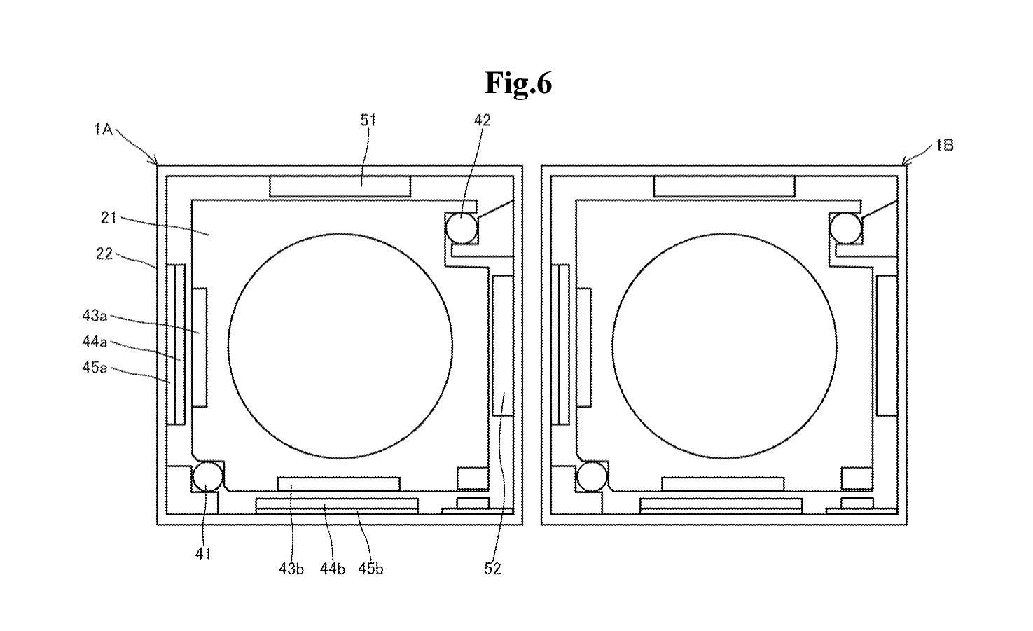

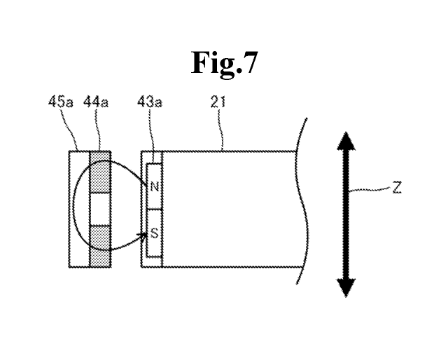

Next, a second exemplary embodiment of the present invention will be described with reference to FIGS. 6 and 7. The lens drive units 1A and 1B in this exemplary embodiment are different from those in the first exemplary embodiment described above in the configuration of the first drive mechanism that realizes the autofocus function. Meanwhile, the configuration of the second drive unit that realizes the stabilizer function is the same as that in the first exemplary embodiment described above. Below, the different configuration will be described in detail.

The lens drive unit 1A in the second exemplary embodiment of the present invention drives the lens barrel 21 to move along the optical axis direction with the use of an autofocus voice coil motor, which is different from the second drive mechanism described above. To be specific, a first drive mechanism (41-45) includes a pair of guide balls 41 and 42, and two autofocus voice coil motors (43-45).

The one guide ball 41 is installed between a concave part and a first guide ball retaining part; the concave part is formed at a corner position between two neighboring sides of the rectangular lens barrel 21, and the first guide ball retaining part has a concave shape and is formed on the housing 22. Moreover, the other guide ball 42 is installed between a second concave part and a second guide ball retaining part; the second concave part is formed at the other corner position of the lens barrel 21 located diagonally opposite the corner position with the one guide ball 41 installed across the lens barrel 21, and the second guide ball retaining part is set at a corner position of the housing 22 so as to face the other corner position. Consequently, when the lens barrel 21 moves along the optical axis direction with respect to the housing 22, the guide balls 41 and 42 inserted therebetween roll, and the lens barrel 21 thereby moves smoothly.

The two autofocus voice coil motors (43-45) are respectively installed near two sides adjacent to each other of four sides forming the outer perimeter of the substantially rectangular lens drive unit 1A. That is, the two autofocus voice coil motors (43-45) are respectively installed near two sides orthogonal to each other. Meanwhile, near the remaining two sides orthogonal to each other forming the outer perimeter of the lens drive unit 1A, voice coil motors 51 and 52 serving as a second drive mechanism.

In the example shown of FIG. 6, the one autofocus voice coil motor (43a, 44a, 45a) is installed near the left-side lateral face of the lens drive unit 1A. To be specific, the one autofocus voice coil motor (43a, 44a, 45a) includes the magnet 43a installed on the lateral face of the lens barrel 21, and the coil 44a and the yoke 45a installed on the lateral face of the housing 22 facing the magnet 43a. Moreover, the other autofocus voice coil motor (43b, 44b, 45b) is installed near the lower-side lateral face of the lens drive unit 1A. To be specific, the other autofocus voice coil motor (43b, 44b, 45b) includes the magnet 43b installed on the lateral face of the lens barrel 21, and the coil 44b and the yoke 45b installed on the lateral face of the housing 22 facing the magnet 43b.

In the one voice coil motor (43a, 44a, 45a), as shown in FIG. 7, magnetic flux from the magnet 43a whose upper and lower sides are magnetized with N pole and S pole on a lens barrel 21 side is concentrated to the yoke 45a. Then, applying electric current to the coil 44a causes drive force to move the lens barrel 21 along the optical axis direction of the lens. To be specific, when electric current is applied to the coil 44a, the lens barrel is driven to reciprocate along the optical axis direction of the lens (Z axis direction) according to Fleming's left hand rule due to the direction of the electric current and the magnetic flux passing the coil 44a from the magnet 43a. Likewise, when electric current is applied to the coil 44b, the other voice coil motor (43b, 44b, 45b) is also driven to reciprocate along the optical axis direction of the lens (Z axis direction) according to Fleming's left hand rule due to the direction of the electric current and the magnetic flux passing the coil 44b from the magnet 43b.

Then, the magnets 43a and 43b of the autofocus voice coil motors are attracted to the yokes 45a and 45b, respectively. Therefore, the lens barrel 21 is attracted toward the left side and the lower side, so that the lens barrel 21 is kept pressed against the one guide ball 41 due to resultant force. Moreover, the lens barrel 21 is supported by the other guide ball 42 on the other side on the diagonal. Herein, by making the shape of the yoke 45b configuring the other voice coil motor larger than the shape of the yoke 45a configuring the one voice coil motor, it is possible to apply clockwise rotational force to the lens barrel 21 because force to attract the magnet 44b of the other voice coil motor becomes larger than force to attract the one voice coil motor. Consequently, it is possible to press the lens barrel 21 against the other guide ball 21.

Consequently, the lens barrel 21 is kept in contact with the housing 22 via the pair of guide balls 41 and 42. Then, movement in a vertical direction to the optical axis in the housing 22 is regulated, so that the posture of the lens barrel 21 becomes stable. As a result, it is possible to realize a stable autofocus operation without instability of the optical axis.

Further, the lens drive unit 1A in this exemplary embodiment includes the voice coil motors 51 and 52 configuring the similar second drive mechanism to that of the first exemplary embodiment, on the different two sides of the outer perimeter from the two sides with the autofocus voice coil motors (43-45) set.

Then, as shown in FIG. 6, the other lens drive unit 1B included by the camera module has the same configuration as the one lens drive unit 1A described above.

Also in this exemplary embodiment, the two lens drive units 1A and 1B described above included by the dual camera are installed as shown in FIGS. 3 and 4 in a similar manner as in the first exemplary embodiment. That is, neither of the magnets 51 and 52 included by the voice coil motors configuring the second drive mechanism are located on at least one of sides where the lens drive units 1A and 1B are located adjacent to each other.

On the sides where the lens drive units 1A and 1B are located adjacent to each other, at least one of the magnets 43a and 43b of the autofocus voice coil motors configuring at least one first drive mechanism is located. For example, in the example of FIG. 3, the magnets 43a and 43b of the two autofocus voice coil motors are located adjacent to each other. In the example of FIG. 4, the magnet (43a or 43b) of the one autofocus voice coil motor and the magnet (51 or 52) of the one voice coil motor configuring the second drive mechanism are adjacent to each other.

However, the autofocus voice coil motors configuring the first drive mechanism include the yokes 45a and 45b outside the magnets 43a and 43b. Therefore, it is possible to inhibit magnetic interference between the magnets adjacent to each other as described above.

As described above, according to the camera module in this exemplary embodiment, magnetic interference of the magnets configuring the lens drive units configuring the dual camera can be inhibited. As a result, it is possible to inhibit of decline of the stabilizer function of the lens drive unit.

Although the present invention has been described above with reference to the exemplary embodiments and so on, the present invention is not limited to the exemplary embodiments. The configurations and details of the present invention can be changed in various manners that can be understood by one skilled in the art within the scope of the present invention.

1. A camera module equipped with two lens drive units adjacent to each other:
wherein the lens drive units each include a first drive mechanism and a second drive mechanism, the first drive mechanism being configured to move a lens along an optical axis direction, the second drive mechanism being configured to move the lens in a vertical direction to the optical axis direction, and
the second drive mechanism includes two voice coil motors that respectively move the lens in two linear directions orthogonal to each other on a vertical plane to the optical axis direction of the lens;
wherein each of the lens drive units has a substantially rectangular outline, and
the two voice coil motors configuring the second drive mechanism are respectively installed near two sides neighboring each other of four sides forming an outer perimeter of the substantially rectangular lens drive unit; and
wherein the two lens drive units are installed so that none of the voice coil motors are located on at least one of sides where the lens drive units are located adjacent to each other.

2. The camera module according to claim 1, wherein the two lens drive units are installed so that none of the voice coil motors are located on the sides where the lens drive units are located adjacent to each other.

3. The camera module according to claim 2, wherein the two lens drive units are installed so that the voice coil motors are located symmetrical about a symmetric line, the symmetric line being the sides where the lens drive units are located adjacent to each other.

4. The camera module according to claim 2, wherein the two lens drive units are installed so that the voice coil motors are located symmetrical about a symmetric point, the symmetric point being near a center of the sides where the lens drive units are located adjacent to each other.

5. An information processing terminal comprising the camera module according to claim 1.
